(19) United States
(12) Patent Application Publication
(10) Pub. No.: US 2023/0264402 A1
(43) Pub. Date: Aug. 24, 2023

(54) CONTROL DEVICE FOR INJECTION MOLDING MACHINE AND CONTROL METHOD FOR INJECTION MOLDING MACHINE

(71) Applicant: FANUC CORPORATION, Minamitsuru-gun (JP)

(72) Inventors: Ryou OOSAKA, Minamitsuru-gun, Yamanashi-ken (JP); Atsushi HORIUCHI, Minamitsuru-gun, Yamanashi-ken (JP)

(21) Appl. No.: 18/007,549

(22) PCT Filed: Jun. 3, 2021
(86) PCT No.: PCT/JP2021/021126

§ 371 Date: Dec. 1, 2022

(30) Foreign Application Priority Data
Jun. 8, 2020 (JP) 2020-099413

(51) Int. Cl. B29C 45/76; B29C 45/40; B29C 45/77; B29C 45/80

(52) U.S. Cl. CPC B29C 45/762; B29C 45/401; B29C 45/7626; B29C 45/77; B29C 45/80; B29C 2945/76006; B29C 2945/76381; B29C 2945/76568; B29C 2945/76722

(57) ABSTRACT

A control device for an injection molding machine includes: a pressure acquiring unit for acquiring resin pressure; an injection control unit for injecting resin into a mold; an ejector control unit for protruding an ejector pin before the resin pressure reaches a predetermined target pressure; and an insertion control unit for causing a supporting member and an attachment plate to support an ejector plate by inserting the supporting member into a gap before the resin pressure reached the predetermined target pressure.

### TECHNICAL FIELD

The present invention relates to a control device for an injection molding machine, and a control method for an injection molding machine.

### BACKGROUND ART

An injection molding machine is a machine that produces a molded product by filling a mold with a melted resin and solidifying the resin. In the field related to such injection molding machines, a control is known in which the resin pressure is maintained at greater than or equal to a predetermined target pressure (holding pressure) until the resin at a gate portion (an entrance portion to the mold) is solidified after the mold has been filled with the resin (for example, refer to the pressure holding operation of JP 2019-171791 A). The control for solidifying the resin in the gate portion is also referred to as gate sealing. By carrying out such gate sealing, the resin that fills the mold is prevented from flowing back to the injection device side.

### SUMMARY OF THE INVENTION

Such an injection molding machine is also capable of producing a molded product having a concave portion or a hole portion therein by causing a pin to project out into a mold prior to solidification of the resin. In this instance, the aforementioned pressure holding operation, which is performed in order to achieve gate sealing, may make it difficult to form a molded product having a concave portion or a hole portion therein with good reliability.

More specifically, in the case of achieving the gate sealing while the pin is projected out into the mold, the pin continues to receive a resin pressure that is greater than or equal to a predetermined magnitude and the pin may be disadvantageously pushed out of the mold prior to the resin becoming solidified. In this case, the concave portion or the hole portion cannot be imparted satisfactorily to the molded product.

Accordingly, the present invention has the object of providing a control device for an injection molding machine and a control method for an injection molding machine, which are capable of forming a molded product having a concave shape and a hole portion with good reliability.

A first aspect of the present invention is characterized by a control device for an injection molding machine, wherein the injection molding machine includes a movable platen configured to move in an opening/closing direction of a mold, a mounting plate provided on a side of the mold of the movable platen, a spacer configured to connect the mold and the mounting plate in a manner so that the mold is opened and closed accompanying movement of the movable platen in the opening/closing direction, the spacer forming an ejector movable space between the mold and the mounting plate, an ejector plate provided in the ejector movable space, and configured to advance and retract toward and from the mold, an ejector pin provided on the ejector plate, and configured to project out toward the mold, a support member configured to be inserted into and removed from a gap formed between the mounting plate and the ejector plate that has advanced, and an injection unit configured to inject a resin that has been plasticized, the control device for the injection molding machine comprising a pressure acquisition unit configured to acquire a resin pressure inside the mold, an injection control unit configured to control the injection unit to thereby inject the resin into an interior of the mold that has been closed, and cause the resin pressure to reach a predetermined target pressure, an ejector control unit configured to cause the ejector plate to advance prior to the resin pressure reaching the predetermined target pressure, to thereby project the ejector pin into the interior of the mold and impart at least one of a concave portion or a hole portion to a shape of the resin inside the mold, and an insertion control unit configured to insert the support member into the gap prior to the resin pressure reaching the predetermined target pressure, to thereby cause the ejector plate that receives the resin pressure to be supported by the support member and the mounting plate.

A second aspect of the present invention is characterized by a control method for an injection molding machine, wherein the injection molding machine includes a movable platen configured to move in an opening/closing direction of a mold, a mounting plate provided on a side of the mold of the movable platen, a spacer configured to connect the mold and the mounting plate in a manner so that the mold is opened and closed accompanying movement of the movable platen in the opening/closing direction, the spacer forming an ejector movable space between the mold and the mounting plate, an ejector plate provided in the ejector movable space, and configured to advance and retract toward and from the mold, an ejector pin provided on the ejector plate, and configured to project out toward the mold, a support member configured to be inserted into and removed from a gap formed between the mounting plate and the ejector plate that has advanced, and an injection unit configured to inject a resin that has been plasticized, the control method for the injection molding machine comprising an injection control step of controlling the injection unit to thereby inject the resin into an interior of the mold that has been closed, an ejector advancing step of, after the injection control step is started, causing the ejector plate to advance to thereby project the ejector pin into the interior of the mold and impart at least one of a concave portion or a hole portion to a shape of the resin inside the mold, an insertion control step of inserting the support member into the gap after the ejector advancing step is started, and a pressure maintaining control step of, after the insertion control step is started, causing a resin pressure inside the mold to reach a predetermined target pressure while the ejector plate is supported by the support member and the mounting plate.

According to the present invention, the control device for the injection molding machine and the control method for the injection molding machine are provided, which are capable of forming a molded product having a concave shape and a hole portion with good reliability.

### BRIEF DESCRIPTION OF DRAWINGS

FIG. 1 is a configuration diagram of an injection molding machine according to an embodiment of the present invention;

FIG. 2 is a top view of a mold opening/closing device according to the embodiment;

FIG. 3 is a side view of the mold opening/closing device shown in FIG. 2;

FIG. 4 is a top view of the mold opening/closing device at a time when ejector pins are projected out into a mold;

FIG. 5 is a side view of the mold opening/closing device shown in FIG. 4;

FIG. 6 is a configuration diagram of an insertion/removal device according to the embodiment;

FIG. 7 is a top view of the mold opening/closing device at a time when a support member is inserted into a gap between a mounting plate and an ejector plate;

FIG. 8 is a top view of the mold opening/closing device at a time when the ejector plate is supported by a support member, the mounting plate, and a movable platen;

FIG. 9 is a side view of the mold opening/closing device shown in FIG. 8;

FIG. 10 is a configuration diagram of a control device according to the embodiment;

FIG. 11 is a flowchart illustrating a process flow of a control method according to the embodiment;

FIG. 12 is a time chart illustrating respective transitions of a resin pressure inside the mold, the position of the ejector plate in an opening/closing direction, and the position of the support member in an insertion/removal direction, according to the control method;

FIG. 13 is a configuration diagram of an ejector device according to a first exemplary modification;

FIG. 14 is a diagram for describing the ejection of a molded product by the ejector device according to the first exemplary modification;

FIG. 15 is a configuration diagram of the control device according to the first exemplary modification;

FIG. 16 is a time chart illustrating respective transitions of the position of the movable platen in the opening/closing direction, the position of the ejector plate in the opening/closing direction, and the position of the support member in the insertion/removal direction, according to the first exemplary modification;

FIG. 17 is a configuration diagram of the control device according to a third exemplary modification;

FIG. 18 is a time chart illustrating respective transitions of the position of the movable platen in the opening/closing direction, the position of the ejector plate in the opening/closing direction, the position of the support member in the insertion/removal direction, and the resin pressure inside the mold, according to the third exemplary modification; and

FIG. 19 is a configuration diagram of the support member according to a fourth exemplary modification when viewed from the opening/closing direction.

### DETAILED DESCRIPTION OF THE INVENTION

A control device for an injection molding machine and a control method for the injection molding machine according to the present invention will be presented and described in detail below in relation to preferred embodiments thereof with reference to the accompanying drawings.

### Embodiment

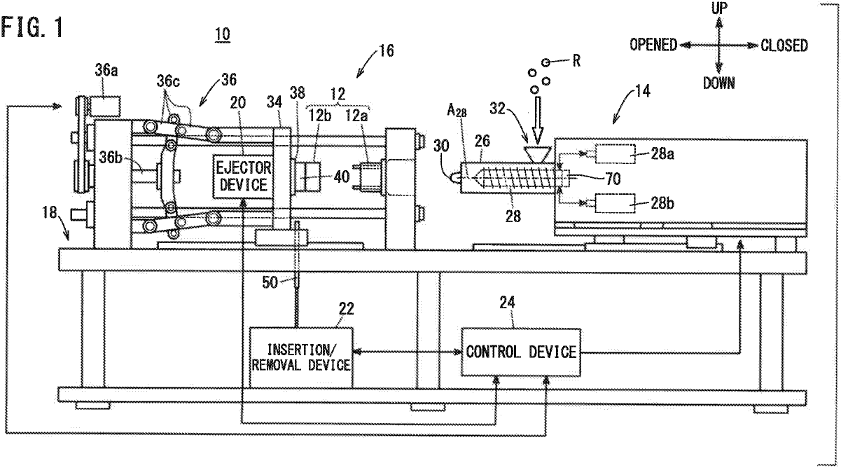

FIG. 1 is a configuration diagram of an injection molding machine 10 according to an embodiment of the present invention.

The injection molding machine 10 is a machine that produces a molded product by injecting a melted (plasticized) resin R into a mold 12 (see FIG. 1) and solidifying the resin. As shown in FIG. 1, the injection molding machine 10 is equipped with an injection device (injection unit) 14, a mold opening/closing device (mold opening/closing unit) 16, and a machine base 18 that supports these components. In addition, the injection molding machine 10 is further equipped with an ejector device 20, an insertion/removal device 22, and a control device 24.

The machine base 18 serves to support the injection device 14 and the mold opening/closing device 16.

The injection device 14 is a device that melts the resin R and injects the resin into the mold 12. The injection device 14 includes a substantially cylindrical cylinder 26 (a heating cylinder), a screw 28 provided inside the cylinder 26, and a nozzle 30. The nozzle 30 is disposed at a distal end of the cylinder 26 on the mold 12 side.

A supply port 32 is provided in the cylinder 26. The supply port 32 is positioned on the end part side of the cylinder 26 that is on an opposite side from the side where the nozzle 30 is provided. The resin R, which is a material for the molded product, is supplied into the cylinder 26 through the supply port 32. The resin R, at a time of being supplied to the supply port 32, for example, is a granular solid material. Further, although illustration thereof is omitted, a heater is provided in the cylinder 26. The heater heats the resin R inside the cylinder 26.

A motor 28a that causes the screw 28 to rotate is connected to the screw 28. The motor 28a is preferably a servomotor from the standpoint of control accuracy. The screw 28 is driven by the motor 28a, and thereby rotates in a predetermined direction of rotation about a central axis A₂₈ thereof. Consequently, the resin R inside the cylinder 26 is delivered under pressure toward the nozzle 30 side while being stirred. The resin R that is delivered under pressure is accumulated inside the cylinder 26 on the nozzle 30 side.

Further, a motor 28b that moves the screw 28 relatively with respect to the cylinder 26 along the central axis A₂₈ is further connected to the screw 28. The motor 28b is preferably a servomotor from the standpoint of control accuracy. The motor 28b is connected to the screw 28, for example, via a non-illustrated ball screw mechanism in order to transmit the rotational force thereof as a linear force to the screw 28. By being driven by the motor 28b, the screw 28 moves (advances) in the direction toward the nozzle 30 within the cylinder 26. Consequently, the resin R that is accumulated inside the cylinder 26 on the nozzle 30 side is extruded (injected) out of the cylinder 26 through the nozzle 30.

The injection device 14 having the configuration described above is capable of melting the resin R inside the cylinder 26 by heating with the heater and stirring with the screw 28. Further, the melted resin R can be injected from the nozzle 30 into the mold 12 due to the pressure generated by advancing the screw 28.

Moreover, although the mold 12 and the nozzle 30 are separated from each other in FIG. 1, the injection of the melted resin R is actually carried out in a (nozzle touching) state in which the mold 12 and the nozzle 30 are connected. Concerning the control that is performed on the injection device 14 at the time when the injection is executed, an example thereof will be described hereinafter as part of a description of the configuration (an injection control unit 64) of the control device 24.

The mold 12 is constituted by a fixed mold 12a and a movable mold 12b. The fixed mold 12a faces toward the injection device 14. The movable mold 12b faces toward the fixed mold 12a on a side opposite from the injection device 14, and is movable along the facing direction. The mold 12 opens at a time when the movable mold 12b separates from the fixed mold 12a, and closes when the movable mold 12b is placed in contact with the fixed mold 12a.

In the present embodiment, as indicated by the arrows in FIG. 1, the direction in which the movable mold 12b approaches the fixed mold 12a is referred to as a “closing direction”, and the opposite direction is referred to as an “opening direction”. Further, the opening direction and the closing direction are collectively referred to as an “opening/closing direction”. The opening/closing direction is perpendicular to the direction of gravity (the vertical direction shown in FIG. 1). It should be noted that the aforementioned central axis A₂₈ of the screw 28 extends along the opening/closing direction.

Movement of the movable mold 12b along the opening/closing direction is realized by the mold opening/closing device 16. The mold opening/closing device 16 is a device including a movable platen 34, a toggle link mechanism 36, a mounting plate 38, and a spacer 40. Among these elements, the movable platen 34 is a plate-like member provided on a side in the opening direction of the movable mold 12b. The toggle link mechanism 36 is a mechanism including a motor 36a that generates a rotational force, a ball screw 36b that converts the rotational force into a linear force in the opening/closing direction, and a plurality of toggle links (in this instance, including toggle heads) 36c that transmit the linear force to the movable platen 34.

The movable platen 34 moves in a reciprocating manner along the opening/closing direction between a mold clamping position and a mold opening position that are determined in advance, by a linear force in the opening/closing direction transmitted from the toggle link mechanism 36.

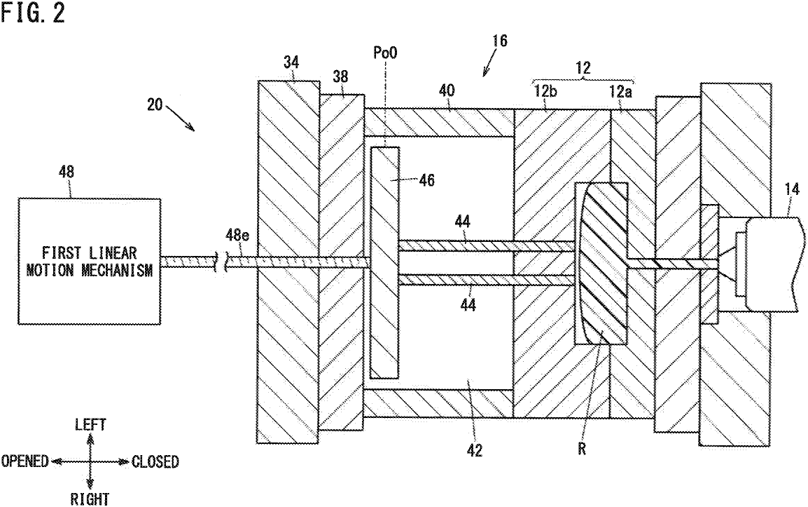

FIG. 2 is a top view of the mold opening/closing device 16 according to the embodiment. Moreover, in FIG. 2, the insertion/removal device 22, which is shown below the mold opening/closing device 16 in FIG. 1, is omitted in order to simplify the illustration.

A description concerning the configuration of the mold opening/closing device 16 will be described with reference to FIG. 2. The mounting plate 38 of the mold opening/closing device 16 is a member that is provided between the movable platen 34 and the spacer 40. The mounting plate 38 connects the movable platen 34 and the spacer 40 to each other. The spacer 40 is a member provided between the movable mold 12b and the mounting plate 38. The spacer 40 connects the movable mold 12b and the mounting plate 38 to each other.

In this manner, according to the present embodiment, the movable mold 12b and the movable platen 34 are connected via the mounting plate 38 and the spacer 40. Consequently, in the present embodiment, opening and closing of the mold 12 (mold opening and mold closing) accompanying the movement of the movable platen 34 can be realized. According to the present embodiment, complete closure of the mold 12 occurs when the movable platen 34 is in the aforementioned mold clamping position, and complete opening of the mold 12 occurs when the movable platen 34 is in the mold opening position.

Further, between the movable mold 12b and the mounting plate 38, a space, which is referred to as an ejector movable space 42 in the present embodiment, is formed by the spacer 40. The ejector movable space 42 is opened toward the insertion/removal device 22 side (downwardly) (refer to FIG. 1).

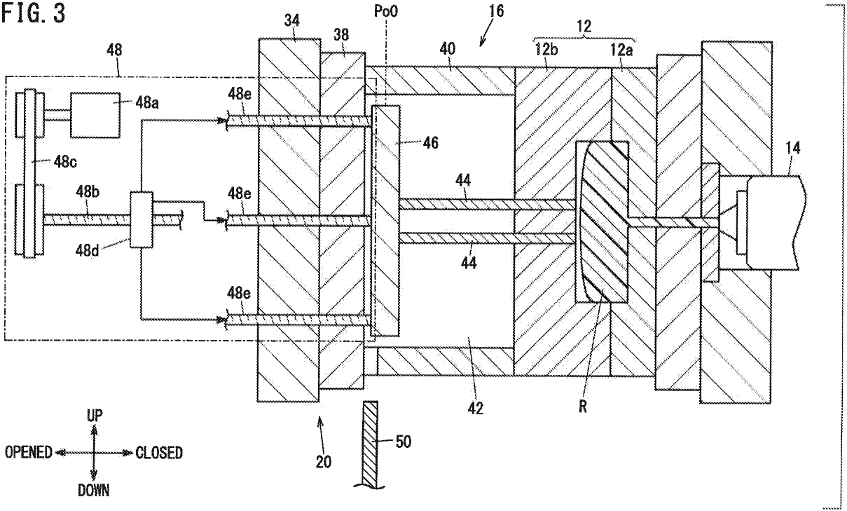

Further, the ejector device 20 will be described with reference to FIG. 2. The ejector device 20 is equipped with ejector pins 44, an ejector plate 46, and a first linear motion mechanism 48. Moreover, a description will be given later with reference to FIG. 3 concerning an example of the configuration of the first linear motion mechanism 48.

The ejector pins 44 are pins, which by projecting out into the mold 12, impart a concave portion (hole portion) shape to the molded product. As shown in FIG. 2, the ejector pins 44 extend in the opening/closing direction inside the ejector movable space 42, and penetrate through the movable mold 12b. Although the number of the ejector pins 44 is two in the example shown in FIG. 2, the present invention is not necessarily limited to this feature.

The ejector plate 46 is a plate that supports the ejector pins 44 on a side opposite from the mold 12. The ejector plate 46 is disposed inside the ejector movable space 42 of the mold opening/closing device 16 that is formed by the spacer 40.

FIG. 3 is a side view of the mold opening/closing device 16 shown in FIG. 2.

The first linear motion mechanism 48 is a mechanism that causes the ejector plate 46 to move linearly in the opening/closing direction. The first linear motion mechanism 48 according to the present embodiment includes a motor 48a, a ball screw 48b, a belt 48c, a nut 48d, and ejector rods 48e connected to the nut 48d.

The motor 48a is a drive source that generates a rotational force. The motor 48a is preferably a servomotor from the standpoint of control accuracy. The ball screw 48b is disposed in a manner so that the axial direction thereof is parallel to the opening/closing direction, and the rotational force of the motor 48a is transmitted thereto via the belt 48c. The nut 48d is screw-engaged with the ball screw 48b. The nut 48d moves along the axial direction of the ball screw 48b (the opening/closing direction) in accordance with the rotation of the ball screw 48b.

The ejector rods 48e are rods that are connected to the nut 48d and the ejector plate 46. According to the present embodiment, as shown in FIG. 3, the ejector rods 48e are disposed in a manner so as to pass through the movable platen 34 and the mounting plate 38.

Moreover, although in the example shown in FIG. 3, three ejector rods 48e are arranged in the vertical direction, the number and the arrangement of the ejector rods 48e are not necessarily limited to this feature. In addition, although in the example shown in FIG. 3, three ejector rods 48e are connected to one nut 48d, the number of the nuts 48d may be three, and one ejector rod 48e may be connected to each of the nuts.

According to the first linear motion mechanism 48 as described above, it is possible to cause the ejector plate 46 to move in the opening/closing direction in accordance with the driving of the motor 48a. The first linear motion mechanism 48 causes the ejector plate 46 to move between two predetermined positions in the opening/closing direction under the control of the control device 24, which will be described in detail later. Hereinafter, one of the two positions on the side in the opening direction will be referred to as a “retracted position PoD”, and the other of the two positions on a side in the closing direction will be referred to as an “advanced position Pol”, Further, the movement of the ejector plate 46 toward the mold 12 (in the closing direction) is also referred to as “advancing (moving forward)”, and the movement thereof in the opposite direction is also referred to as “retracting (moving backward)”.

According to the present embodiment, the position of the ejector plate 46 that is illustrated in FIGS. 2 and 3 is the retracted position Po0. Moreover, in the present embodiment, the “position of the ejector plate 46” refers to the position of the center of the ejector plate 46 in the thickness direction of the ejector plate 46 (the opening/closing direction). In other words, according to the present embodiment, when the ejector plate 46 is in the retracted position Po0, a situation is indicated in which the center of the ejector plate 46 in the thickness direction of the ejector plate 46 is in the retracted position Po0. However, the position of the ejector plate 46 is not limited to this feature. For example, the position of the surface, on the side in the opening direction, of the ejector plate 46 in the opening/closing direction may also be regarded as the position of the ejector plate 46. Further, the position of the surface, on the side in the closing direction, of the ejector plate 46 in the opening/closing direction may also be regarded as the position of the ejector plate 46.

Further, according to the present embodiment, when the ejector plate 46 is in the retracted position Po0, the distal ends of the ejector pins 44 on the mold 12 side and the inner surface of the movable mold 12b lie flush with each other, but the present invention is not necessarily limited to this feature.

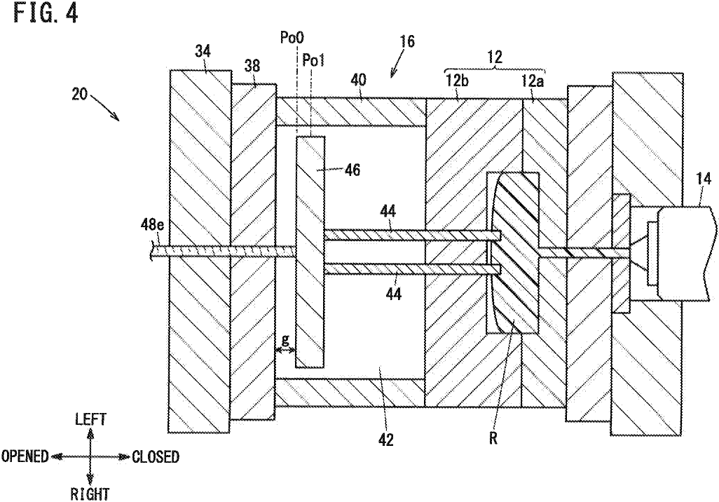

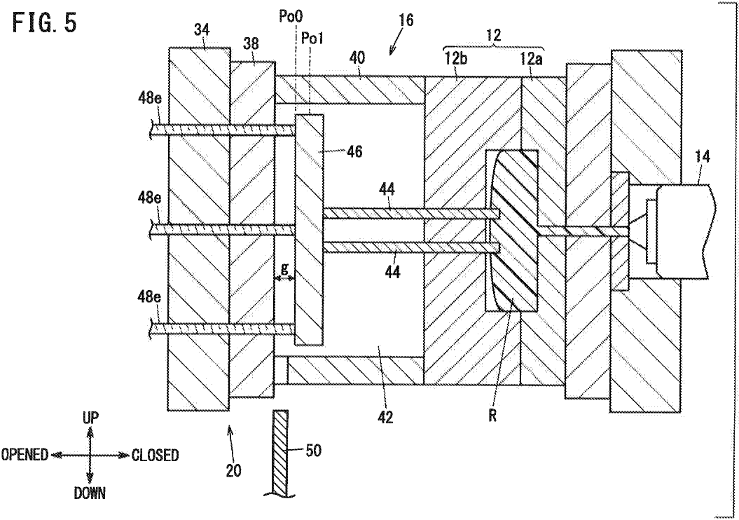

FIG. 4 is a top view of the mold opening/closing device 16 at a time when the ejector pins 44 are projected out into the mold 12. FIG. 5 is a side view of the mold opening/closing device 16 shown in FIG. 4. It should be noted that the insertion/removal device 22 is omitted from illustration in FIG. 4 in the same manner as in FIG. 2.

According to the present embodiment, the position of the ejector plate 46 that is illustrated in FIGS. 4 and 5 is the advanced position Pol. As discussed previously, when the ejector plate 46 is in the advanced position Pol, a situation is indicated in which the center of the ejector plate 46 in the thickness direction is in the advanced position Pol. When the ejector plate 46 advances, as shown in FIGS. 4 and 5, a gap g between the mounting plate 38 and the ejector plate 46 expands.

Further, when the ejector plate 46 is in the advanced position Pol, the ejector pins 44 are projected out into the mold 12. By the ejector pins 44 being projected out in this manner, concave portions (hole portions) are formed in the resin R that fills the mold 12.

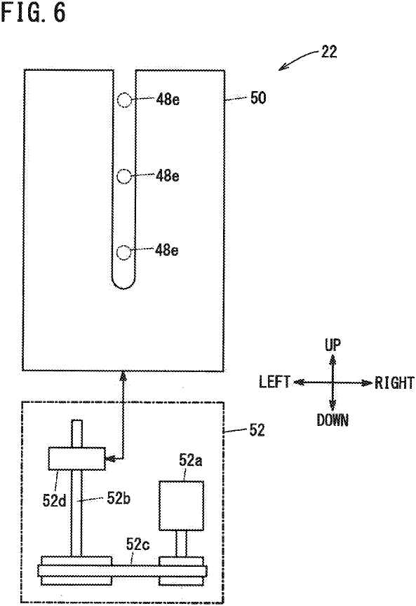

FIG. 6 is a configuration diagram of the insertion/removal device 22 according to the embodiment.

Next, a description will be given concerning the insertion/removal device 22. As shown in FIG. 1, according to the present embodiment, the insertion/removal device 22 is provided below the mold opening/closing device 16 and the mold 12. The insertion/removal device 22 includes a support member 50 and a second linear motion mechanism 52.

The support member 50 is a member that is inserted into and removed from the gap g formed between the mounting plate 38 and the ejector plate 46. According to the present embodiment, the upward direction is an insertion direction of the support member 50, and the downward direction is a removal direction thereof.

According to the present embodiment, the support member 50 is a U-shaped slide plate. A thickness (a length in the opening/closing direction) of the support member 50 is less than the width of the gap g in the opening/closing direction at a time when the ejector plate 46 is in the advanced position Pol.

By making the shape of the support member 50 U shape, when the support member 50 is inserted into the gap g, interference between the three ejector rods 48e, which are arranged alongside one another in the vertical direction as discussed previously, and the support member 50 can be avoided (refer to FIG. 6). Moreover, naturally, in the case that the number and the arrangement of the ejector rods 48e are changed, the shape of the support member 50 may be changed in accordance with such a change, so that mutual interference between the ejector rods 48e and the support member 50 can be avoided.

The second linear motion mechanism 52 is a mechanism for inserting and removing the support member 50 into and from the gap g, by causing the support member 50 to move linearly in the+ insertion/removal direction. The second linear motion mechanism 52, for example as shown in FIG. 6, includes a motor 52a, a ball screw 52b, a belt 52c, and a nut 52d.

The motor 52a is a drive source that generates a rotational force. The motor 52a is preferably a servomotor from the standpoint of control accuracy. The ball screw 52b is disposed in a manner so that the axial direction thereof is parallel to the insertion/removal direction of the support member 50, and the rotational force of the motor 52a is transmitted thereto via the belt 52c. The nut 52d is screw-engaged with the ball screw 52b, and moves along the axial direction of the ball screw 52b (the insertion/removal direction) in accordance with the rotation of the ball screw 52b.

According to the second linear motion mechanism 52 as described above, the support member 50 is capable of moving along the insertion/removal direction by being connected to the nut 52d. It should be noted that the configuration of the second linear motion mechanism 52 is not necessarily limited to this feature, and for example, the support member 50 may be made to move linearly by a linear motion actuator such as a linear motor or a power cylinder.

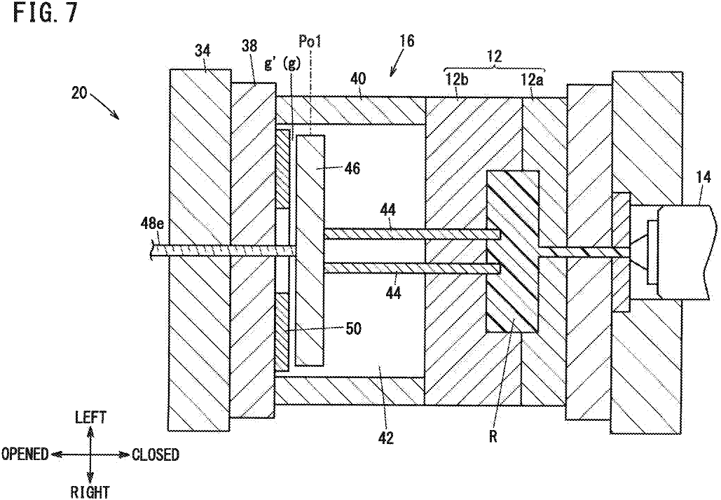

FIG. 7 is a top view of the mold opening/closing device 16 at a time when the support member 50 is inserted into the gap g formed between the mounting plate 38 and the ejector plate 46.

According to the present embodiment, the width of the gap g in the opening/closing direction is greater than the thickness of the support member 50. As a result, as shown in FIG. 7, the support member 50 can be inserted into the gap g while leaving a portion (g′) of the gap g between the support member 50 and the ejector plate 46. By providing the gap g′ between the support member 50 and the ejector plate 46, the two members are prevented from rubbing against each other.

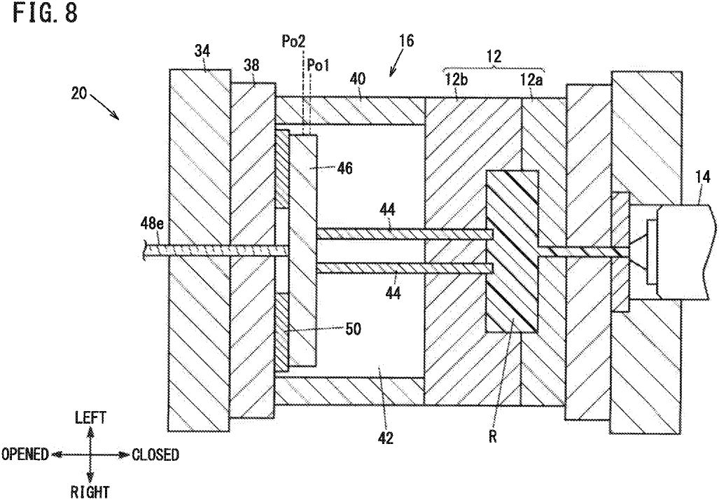

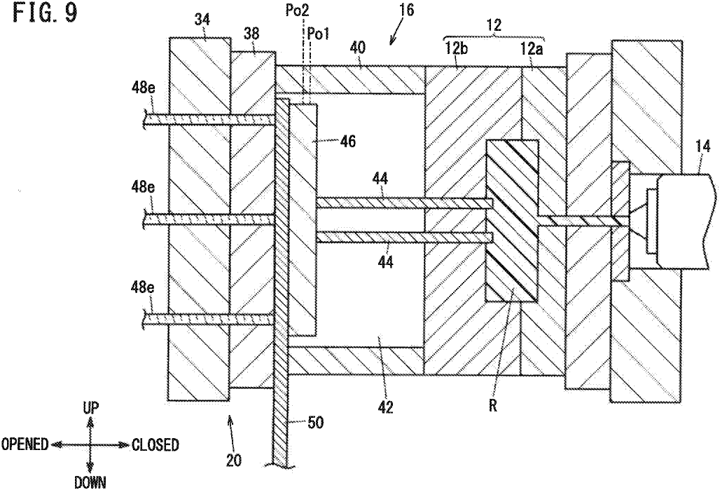

FIG. 8 is a top view of the mold opening/closing device 16 at a time when the ejector plate 46 is supported by the support member 50, the mounting plate 38, and the movable platen 34. FIG. 9 is a side view of the mold opening/closing device 16 shown in FIG. 8.

As shown in FIGS. 8 and 9, the gap g′ can be filled by causing the ejector plate 46 to be retracted from the advanced position Pol. Hereinafter, the position of the ejector plate 46, which is in contact with the support member 50 that is inserted into the gap g, will be referred to as a “pressure receiving position Po2”.

The ejector plate 46, which has been retracted to the pressure receiving position Po2, is supported from the side in the opening direction by the support member 50, the mounting plate 38, and the movable platen 34. In this state, the support member 50, the mounting plate 38, and the movable platen 34 prevent the ejector plate 46 from being retracted.

Moreover, in the case it is desired to impart a hole portion to the molded product, insertion holes (not shown) through which the ejector pins 44 are capable of being inserted may be provided in advance in the fixed mold 12a. The insertion holes are holes that receive, on the fixed mold 12a side, the ejector pins 44 that have been projected out. In the case of the present embodiment, it is necessary for the insertion holes to have a depth that allows the insertion of the ejector pins 44 therein at least at a time when the ejector plate 46 is in the advanced position Pol. Consequently, in the case it is desired to impart the hole portion to the molded product, the ejector plate 46 can be advanced until reaching the advanced position Pol. Further, the aforementioned pressure receiving position Po2 must be determined in a manner so that the ejector pins 44 are not pulled out from the insertion holes when the ejector plate 46 has been retracted to the pressure receiving position Po2. Consequently, the state in which the ejector pins 44 penetrate through the resin R inside the mold 12 can be maintained even when the ejector plate 46 has been retracted to the pressure receiving position Po2.

The foregoing are examples of the configurations of the injection device 14, the mold opening/closing device 16, the ejector device 20, and the insertion/removal device 22. Next, a description will be given of the control device 24 that controls these elements.

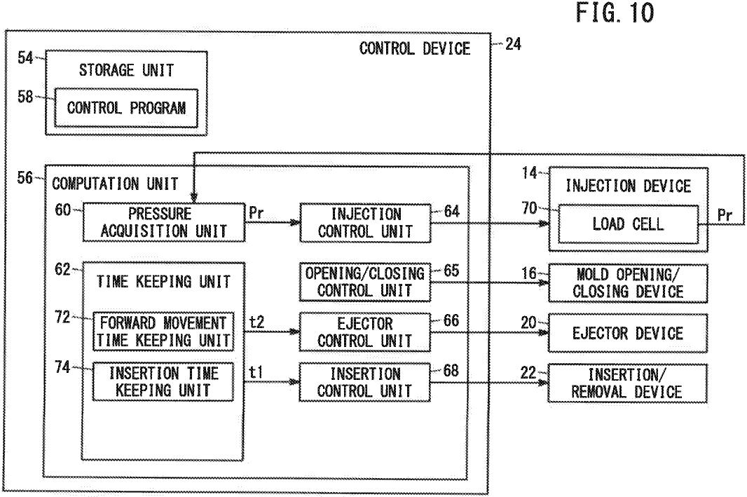

FIG. 10 is a configuration diagram of the control device 24 according to the embodiment.

The control device 24 is configured, for example, as a numerical control device (CNC) that numerically controls the injection molding machine 10. The control device 24 is equipped with a storage unit 54, and a computation unit 56.

The storage unit 54 serves to store information. The storage unit 54 is constituted by a memory such as a RAM (Random Access Memory) or a ROM (Read Only Memory), for example. The storage unit 54 according to the present embodiment stores a predetermined control program 58 in advance.

The control program 58 is a program that defines a method of controlling the injection molding machine 10 (hereinafter simply referred to as a “control method”) that is capable of forming a molded product having a concave shape with good reliability. A description will be given later concerning the configuration of the control method.

The computation unit 56 processes information by performing calculations. The computation unit 56 is constituted by a processor such as a CPU (Central Processing Unit) or a GPU (Graphics Processing Unit). The computation unit 56 of the present embodiment includes a pressure acquisition unit 60, a time keeping unit 62, an injection control unit 64, an opening/closing control unit 65, an ejector control unit 66, and an insertion control unit 68. These respective elements are realized by the computation unit 56 reading in and executing the aforementioned control program 58.

The pressure acquisition unit 60 serves to acquire a resin pressure Pr. According to the present embodiment, a load cell 70 is provided on the screw 28, and the resin pressure Pr is acquired from the load cell 70. In this case, the load cell 70 is attached, for example, to an end part of the screw 28 on the side in the closing direction (refer to FIG. 1).

The time keeping unit 62 is a so-called timer that measures time. The time keeping unit 62 of the present embodiment includes a forward movement time keeping unit 72 and an insertion time keeping unit 74 which measure time at timings that differ from each other in accordance with requests from the ejector control unit 66. Among these time keeping units, the forward movement time keeping unit 72 measures an elapsed time (forward movement time) t1 after the ejector plate 46 starts moving from the retracted position Po0 toward the advanced position Pol. Further, the insertion time keeping unit 74 measures an elapsed time (insertion time) t2 from when the insertion of the support member 50 is started after the ejector pins 44 have been projected out.

The injection control unit 64, by controlling the motor 28a and the motor 28b of the injection device 14, serves to measure the amount of the resin R and carry out the injection of the resin R.

The measurement of the amount serves as a control in which a predetermined amount of the resin R, which is injected into the mold 12, is accumulated inside the cylinder 26 on the nozzle 30 side. The injection control unit 64, by rotating the screw 28 in a predetermined direction of rotation, is capable of delivering under pressure the resin R, which is supplied from the supply port 32, to the nozzle 30 side in the interior of the cylinder 26.

After the measurement is completed, the injection control unit 64 maintains the resin pressure Pr at less than or equal to a predetermined standby pressure Pr0. The standby pressure Pr0 is an adjustment target value of the resin pressure Pr, which is set in a manner so that the resin R which is measured does not leak (is not drawn) from the cylinder 26 through the nozzle 30, and is set to zero (atmospheric pressure) according to the present embodiment. However, the standby pressure Pr0 is not necessarily limited in this manner, and for example, may be a value in close proximity to zero. The injection control unit 64 can appropriately refer to the standby pressure Pr0, for example, by storing the standby pressure Pr0 in the storage unit 54 in advance.

In the case that the resin pressure Pr exceeds the standby pressure Pr0, the injection control unit 64 causes the screw 28 to be retracted. Consequently, the injection control unit 64 enables the resin pressure Pr to be reduced. Moreover, the injection control unit 64 is also capable of reducing the resin pressure Pr by causing the screw 28 to rotate in an opposite direction of rotation to that when the resin R is delivered under pressure to the nozzle 30 side.

On the other hand, in the case that the resin pressure Pr is less than the standby pressure Pr0, the injection control unit 64 may cause the screw 28 to advance in a manner so that the resin pressure Pr does not exceed the standby pressure Pr0. Consequently, the injection control unit 64 enables the resin pressure Pr to be raised. Moreover, the injection control unit 64 is also capable of raising the resin pressure Pr by causing the screw 28 to rotate in the same direction of rotation as that when the resin R is delivered under pressure to the nozzle 30 side.

The injection serves as a control of delivering under pressure a predetermined measured amount of the resin R from the cylinder 26 into the interior of the mold 12 through the nozzle 30. The injection control unit 64, by causing the screw 28 to advance, is capable of delivering the resin R under pressure from the cylinder 26 into the interior of the mold 12. It should be noted that the injection control unit 64 may cause the screw 28 to rotate at this time. By carrying out the injection, the resin pressure Pr rises from the standby pressure Pr0 and reaches a target pressure Pr1. More specifically, by the resin R being delivered under pressure by the screw 28, the resin pressure Pr rises from the standby pressure Pr0 and reaches the target pressure Pr1.

After having completed the injection, the injection control unit 64, while referring to the resin pressure Pr acquired by the pressure acquisition unit 60, maintains the resin pressure Pr at the target pressure Pr1. More specifically, after having completed filling the mold 12 with the resin R, the injection control unit 64 maintains the resin pressure Pr at the target pressure Pr1 while referring to the resin pressure Pr acquired by the pressure acquisition unit 60. At this time, the injection control unit 64 can maintain the resin pressure Pr at the target pressure Pr1 by controlling the advancement/retraction and the rotation of the screw 28, in the same manner as when maintaining the resin pressure Pr at the standby pressure Pr0. For example, the injection control unit 64 is capable of preventing the resin pressure Pr from decreasing by maintaining the position of the screw 28 by driving the motor 28b, in a manner so that the screw 28 is not pushed back and retracted by the resin R that is about to flow back from the mold 12.

However, after the injection is started, the injection control unit 64 preferably maintains the resin pressure Pr below the predetermined target pressure Pr1 (and greater than or equal to the standby pressure Pr0) until the elapsed time t2 measured by the insertion time keeping unit 74 reaches at least a predetermined maintenance release time Tb. The reason for this feature will be explained later. Adjustment of the timing at which the resin pressure Pr after the start of injection is made to reach the target pressure Pr1 can be realized, for example, by appropriately adjusting the advancing speed and the rotational speed of the screw 28 at the time when the injection is executed. More specifically, the adjustment of the timing at which filling of the mold 12 with the resin R is completed can be realized, for example, by appropriately adjusting the advancing speed and the rotational speed of the screw 28 at the time when the injection is executed.

After having reached the predetermined target pressure Pr1, the resin pressure Pr is preferably maintained at greater than or equal to the target pressure Pr1 at least until the resin R at an inlet portion provided in the mold 12 is solidified (a gate sealing is formed). Consequently, the resin R is prevented from flowing back from the mold 12 into the injection device 14. Thereafter, by opening the mold 12 after the resin R in the mold 12 is solidified, the operator of the injection molding machine 10 is capable of obtaining the molded product which is made from the solidified resin R.

The opening/closing control unit 65 controls the opening and closing of the mold 12 by controlling the mold opening/closing device 16. The opening/closing control unit 65, by controlling the driving of the motor 36a of the mold opening/closing device 16, causes the movable platen 34 to move in a reciprocating manner between the mold opening position and the mold clamping position. Consequently, the opening and closing of the mold 12 is controlled.

The ejector control unit 66, by controlling the movement of the ejector plate 46, causes the ejector pins 44 to project out into the mold 12 prior to the resin R in the mold 12 becoming solidified. The specific timing at which the ejector pins 44 are projected out is appropriately set, however, if they are projected out at a time when the filling rate of the resin R into the mold 12 is low, there is a high concern that a molding defect such as a weld line may occur. Accordingly, the timing at which the ejector pins 44 are projected out is preferably set while a spatial margin for inserting the ejector pins 44 exists inside the mold 12, and after the mold 12 has been filled with the resin R to a certain extent.

After causing the ejector plate 46 to move to the advanced position Pol, the ejector control unit 66 maintains the ejector plate 46 in the advanced position Pol until the elapsed time t2 measured by the insertion time keeping unit 74 reaches the predetermined maintenance release time Tb. Further, when the elapsed time t2 has reached the predetermined maintenance release time Tb, the ejector plate 46 is retracted to the pressure receiving position Po2.

The predetermined maintenance release time Tb is information that is stored in the storage unit 54 in advance, so that the ejector control unit 66 can appropriately refer to the predetermined maintenance release time Tb. The predetermined maintenance release time Tb is appropriately determined in a manner so that the ejector control unit 66 can continue to maintain the position of the ejector plate 46 from when the ejector pins 44 are projected out to when the support member 50 is inserted into the gap g.

Further, as discussed previously, the ejector control unit 66 requests the time keeping unit 62 to measure the elapsed time t1 and the elapsed time t2. The ejector control unit 66 makes a request to initiate measurement of the elapsed time t1 when the ejector control unit 66 causes the ejector plate 46 to advance from the retracted position Po0. Further, the ejector control unit 66 makes a request to initiate measurement of the elapsed time t2 when the ejector plate 46 has reached the advanced position Pol.

The insertion control unit 68 serves to control the insertion and removal of the support member 50, whereby the support member 50 is inserted between the mounting plate 38 and the ejector plate 46 after the ejector pins 44 have been projected out. The insertion control unit 68 determines whether or not the ejector pins 44 have been projected out, based on the elapsed time t1 that is measured by the forward movement time keeping unit 72.

More specifically, upon being triggered by the ejector control unit 66 starting to move the ejector plate 46 toward the advanced position Pol, measurement of the elapsed time t1 is started. In the case that the elapsed time t1 has reached a predetermined insertion start time Ta, the insertion control unit 68 controls the insertion/removal device 22 to move the support member 50 in the insertion direction (upwardly).

The predetermined insertion start time Ta is information that is stored in the storage unit 54 in advance, so that the insertion control unit 68 can appropriately refer to the predetermined insertion start time Ta. The predetermined insertion start time Ta is appropriately determined in a manner so that the support member 50 does not collide with a lower end part of the ejector plate 46 after the support member 50 starts to be inserted.

Consequently, the support member 50 is inserted between the mounting plate 38 and the ejector plate 46. Further, upon being triggered by the support member 50 starting to move in the insertion direction, measurement of the aforementioned elapsed time t2 is started.

The foregoing is an example of the configuration of the control device 24 of the present embodiment. Next, a description will be given of a process flow of the aforementioned control method which is executed by this control device 24.

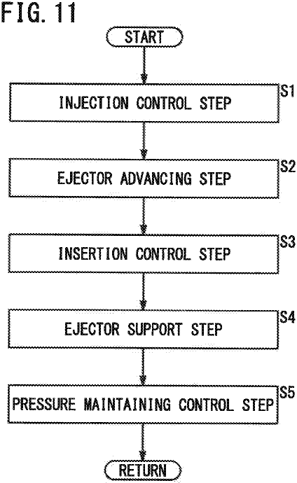

FIG. 11 is a flowchart illustrating a process flow of the control method according to the embodiment.

As shown in FIG. 11, the control method includes an injection control step S1, an ejector advancing step S2, an insertion control step S3, an ejector support step S4, and a pressure maintaining control step S5.

The injection control step S1 is a step of injecting the resin R into the interior of the closed mold 12 by controlling the injection device 14. This step is executed by the injection control unit 64 controlling the advancement/retraction and the rotation of the screw 28. It should be noted that the execution of this step is premised on the measurement of the amount of the resin R having been completed.

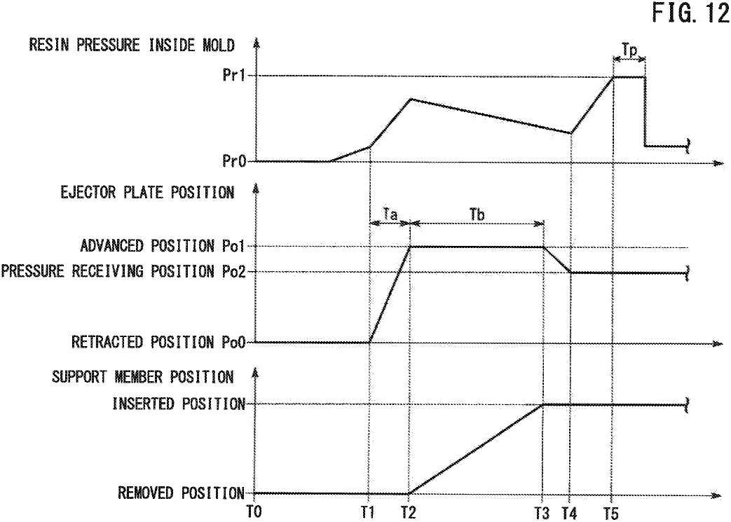

FIG. 12 is a time chart illustrating respective transitions of the resin pressure Pr inside the mold 12, the position of the ejector plate 46 in the opening/closing direction, and the position of the support member 50 in the insertion/removal direction, according to the control method.

T0 in FIG. 12 indicates a point in time when the injection control step S1 is started. Until T0, the resin pressure Pr is adjusted to the standby pressure Pr0, and after T0 when the injection control step S1 is started, the resin pressure Pr becomes greater than the standby pressure Pr0. The injection control step S1 continues to be performed until T5.

The ejector advancing step S2 is a step of, after the injection control step S1 is started, causing the ejector plate 46 to advance to thereby project the ejector pins 44 into the mold 12 and impart at least one of a concave portion or a hole portion to the shape of the resin R inside the mold 12. This step is executed by the ejector control unit 66.

The time slot during which the ejector advancing step S2 is performed is from T1 to T2 in FIG. 12. T1 takes place after T0, and T2 takes place before T5. Ta in FIG. 12 illustrates a length of time from T1 until the above-described predetermined insertion start time Ta is reached.

The insertion control step S3 is a step of inserting the support member 50 between the mounting plate 38 and the ejector plate 46 after the ejector pins 44 have been projected out, by controlling the insertion and removal of the support member 50. This step is executed by the insertion control unit 68.

The time slot during which the insertion control step S3 is performed is from T2 to T3 in FIG. 12. Tb in FIG. 12 illustrates a length of time from T2 until the above-described maintenance release time Tb is reached. Further, the removed position in FIG. 12 is a predetermined initial position of the support member 50 when starting to move toward the gap g, and the inserted position is a target position of the support member 50 moving toward the gap g.

The ejector support step S4 is a step of retracting the ejector plate 46 from the advanced position Pol to the pressure receiving position Po2. By performing this step, the ejector plate 46 is supported from the side in the opening direction by the support member 50, the mounting plate 38, and the movable platen 34. This step is performed by the ejector control unit 66 after the elapsed time t2 has reached the predetermined maintenance release time Tb.

The time slot during which the ejector support step S4 is performed is from T3 to T4 in FIG. 12. T4 takes place before T5. In other words, in the same manner as in the ejector advancing step S2 and the insertion control step S3, the ejector support step S4 is completed prior to the resin pressure Pr reaching the target pressure Pr1.

The pressure maintaining control step S5 is a step of maintaining the resin pressure Pr inside the mold 12 at greater than or equal to the predetermined target pressure Pr1 while the ejector plate 46 is supported by the support member 50 and the mounting plate 38. This step is executed by the injection control unit 64 controlling the advancement/retraction and the rotation of the screw 28 while referring to the resin pressure Pr. The resin pressure Pr referred to by the injection control unit 64 at this time is appropriately acquired by the pressure acquisition unit 60 during this step.

As illustrated in FIG. 12, the pressure maintaining control step S5 is started from T5 and continues for a predetermined time period (indicated by Tp in FIG. 12). During this time, the resin pressure Pr is maintained at greater than or equal to the predetermined target pressure Pr1. Consequently, gate sealing can be achieved. After the gate sealing has been achieved, the resin pressure Pr may be made less than the predetermined target pressure Pr1.

In accordance with the control method described above, it is possible to form the molded product having a concave shape with good reliability. The reason for this feature is as follows.

More specifically, after the resin pressure Pr has reached the target pressure Pr1 in the pressure maintaining control step S5, the resin pressure Pr is maintained at greater than or equal to the target pressure Pr1 until the gate sealing is achieved. The target pressure Pr1 is applied through the resin R to the ejector pins 44 that are projected out into the mold 12, and is also applied through the resin R to the ejector plate 46 on which the ejector pins 44 are supported.

In this instance, in the case that the ejector plate 46 is not supported from the side in the opening direction by the support member 50, a concern arises in that the ejector pins 44, which have received the resin pressure Pr that is greater than or equal to the target pressure Pr1, may be pushed out from the mold 12 to the side in the opening direction prior to the resin R becoming solidified. In such a case, it is not possible for the molded product having a concave (hole) shape to be formed with good quality.

In this regard, according to the present embodiment, the ejector plate 46, which receives via the ejector pins 44 the resin pressure Pr that is greater than or equal to the target pressure Pr1, is supported by the support member 50, the mounting plate 38, and the movable platen 34. As a result, the positions of the ejector plate 46 and the ejector pins 44 are suitably maintained, and therefore, a molded product of satisfactory quality having a concave shape can be formed with good reliability.

Further, in the present embodiment, the reason as to why the position of the ejector plate 46 is maintained by the ejector control unit 66 until the predetermined maintenance release time Tb is reached is as follows. More specifically, according to the present embodiment, after the maintenance release time Tb, the ejector plate 46 is supported by the support member 50, the mounting plate 38, and the movable platen 34. Accordingly, at a stage at which the ejector plate 46 and the ejector pins 44 receive the resin pressure Pr which is greater than or equal to the target pressure Pr1, the position of the ejector plate 46 can be maintained even if the first linear motion mechanism 48 is not driven. Consequently, an output sufficient to maintain the position of the ejector plate 46 against the resin pressure Pr which is greater than or equal to the target pressure Pr1 is no longer required for the first linear motion mechanism 48, and therefore, such a configuration is advantageous in terms of reducing the energy consumed by the first linear motion mechanism 48.

In the foregoing manner, according to the present embodiment, the control device 24 for the injection molding machine 10 and the control method for the injection molding machine 10 are provided, which are capable of forming a molded product having a concave shape with good reliability.

### Exemplary Modifications

The embodiment has been described above as one example of the present invention. various modifications or improvements can be added to the above-described embodiment. Further, it is clear from the description of the scope of the claims that other modes to which such modifications or improvements have been added can be included within the technical scope of the present invention.

Hereinafter, several exemplary modifications according to the embodiment will be presented and specifically described. However, descriptions of matters that overlap with those of the embodiment will be omitted as appropriate.

### Exemplary Modification 1

The control device 24 may further control the removal of the molded product from the mold 12 after the resin R inside the mold 12 is solidified, and control the removal of the support member 50 from between the mounting plate 38 and the ejector plate 46. Hereinafter, the control device 24 which is capable of executing such a control will be described.

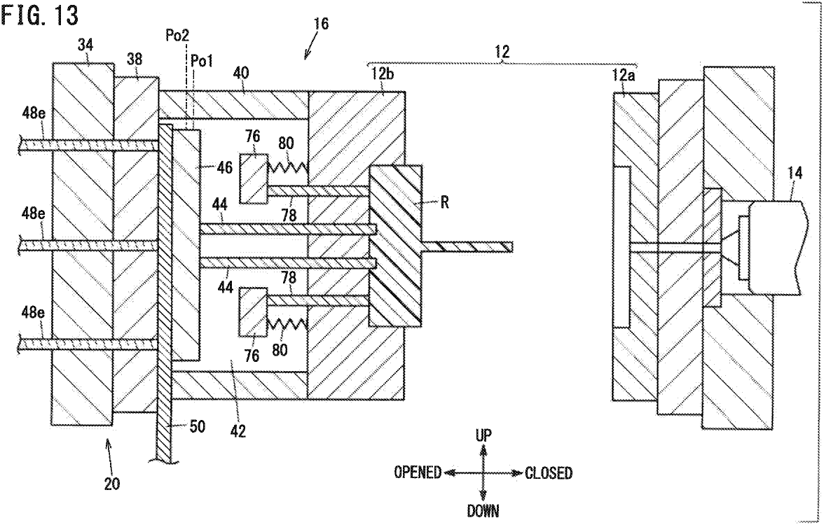

FIG. 13 is a configuration diagram of the ejector device 20 according to a first exemplary modification. FIG. 13 is shown from the same viewpoint as FIG. 3.

Prior to describing the control device 24 of the present exemplary modification, first, an example of the configuration of the ejector device 20, which serves as an object to be controlled, will be described. As shown in FIG. 13, according to the present exemplary modification, the ejector device 20 further includes protruding plates 76, protruding pins 78, and elastic members 80.

The protruding plates 76 are plates that support the protruding pins 78 on a side opposite from the mold 12. The protruding plates 76 are provided inside the ejector movable space 42 on the side in the closing direction of the ejector plate 46 that is in the advanced position Pol, and are disposed in a manner so as to avoid the ejector pins 44.

The protruding pins 78 are pins provided in order to eject and remove the molded product from the opened mold 12. In the same manner as the ejector pins 44 (refer to FIG. 3), when the ejector plate 46 is in the retracted position Po0, the protruding pins 78 illustrated in FIG. 13 are made to be flush with the inner surface of the movable mold 12b when they are not projected out into the mold 12.

The elastic members 80 are members disposed between the protruding plates 76 and the movable mold 12b, and has an elasticity so as to be compressed by the protruding plates 76 moving in the closing direction and to generate a repulsive force against such compression. Moreover, although in FIG. 13, compression springs are illustrated as a specific example of the elastic members 80, the elastic members 80 are not necessarily limited to being compression springs, as long as the elastic members generate a repulsive force against compression in the opening/closing direction.

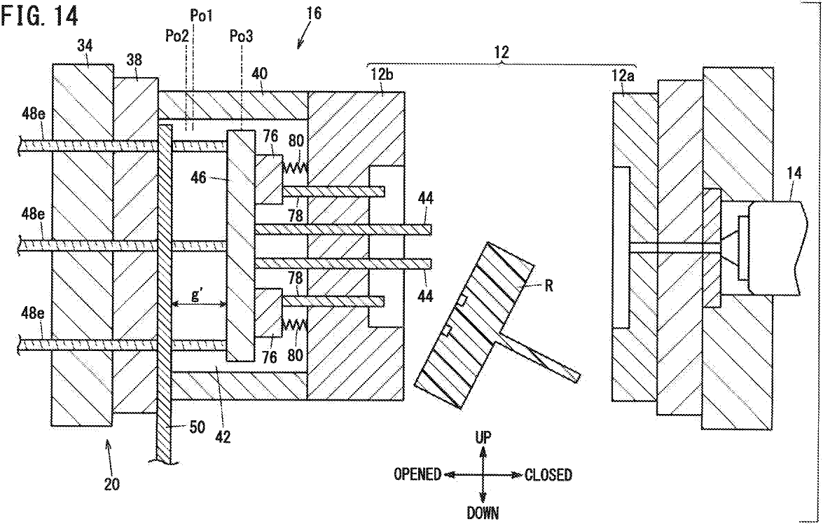

FIG. 14 is a diagram for describing the ejection of the molded product by the ejector device 20 according to the first exemplary modification. FIG. 14 is shown from the same viewpoint as FIG. 13.

According to the ejector device 20 described above, as shown in FIG. 14, the protruding pins 78 can be projected out into the mold 12 by the protruding plates 76 being pushed to the side in the closing direction by the ejector plate 46. Consequently, the molded product (the solidified resin R) can be taken out from the mold 12. An arrival position of the ejector plate 46, which is advanced in order to push the protruding plates 76, can be determined in advance, and according to the present exemplary modification, the arrival position is also referred to as an “ejected position Po3”.

The protruding plates 76 that have been moved in the closing direction can be returned to their original positions by the aforementioned elastic members 80. More specifically, when the ejector plate 46 is retracted from the ejected position Po3, the protruding plates 76 shown in FIG. 14 can be returned to their original positions (refer to FIG. 13) due to a force in the opening direction being received from the elastic members 80.

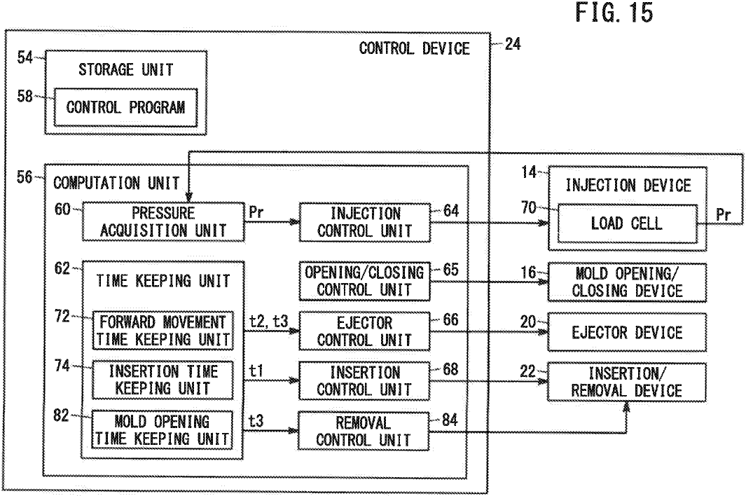

FIG. 15 is a configuration diagram of the control device 24 according to the first exemplary modification.

A description will be given of an example of the configuration of the control device 24 according to the present exemplary modification. As shown in FIG. 15, the control device 24 according to the present exemplary modification is further equipped with a mold opening time keeping unit 82 and a removal control unit 84. The configuration of the control device 24 according to the present exemplary modification differs from that of the embodiment (see FIG. 10) at least in this respect. It should be noted that the control program 58 can be stored in the storage unit 54 in the same manner as in the embodiment, however, the content thereof may be appropriately changed in accordance with the configuration of the computation unit 56 of the present exemplary modification.

The mold opening time keeping unit 82 measures an elapsed time (the mold opening time) t3 from the start of mold opening of the mold 12. The elapsed time t3 is referred to by the ejector control unit 66 and the removal control unit 84.

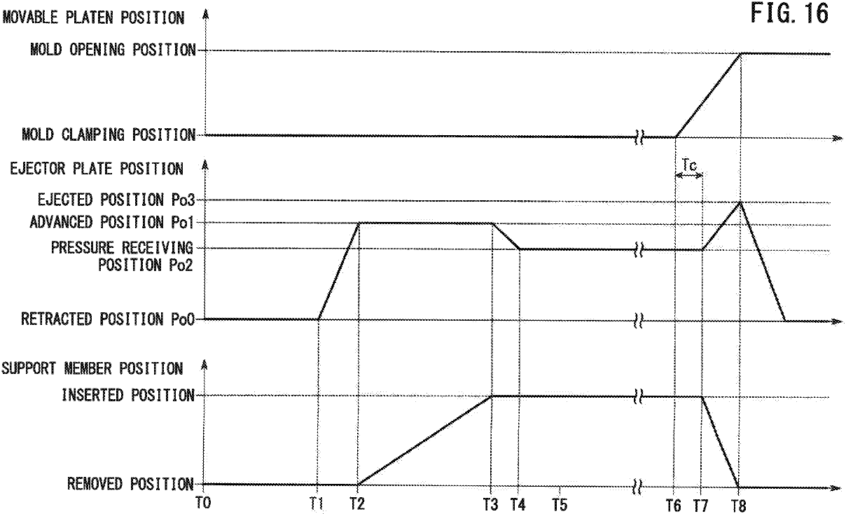

FIG. 16 is a time chart illustrating respective transitions of the position of the movable platen 34 in the opening/closing direction, the position of the ejector plate 46 in the opening/closing direction, and the position of the support member 50 in the insertion/removal direction, according to the first exemplary modification.

T6 shown in FIG. 16 illustrates a starting point of time keeping by the mold opening time keeping unit 82. More specifically, T6 shown in FIG. 16 illustrates a point in time at which the mold opening of the mold 12 is initiated. Moreover, it is assumed that the resin R inside the mold 12 becomes sufficiently solidified at the point in time T6.

In relation to the elapsed time t3, the ejector control unit 66 performs the same control as in the embodiment, and in addition, also performs the following control. More specifically, in the case that the elapsed time t3 has reached a predetermined removal start time Tc, the ejector control unit 66 causes the ejector plate 46 to advance to the ejected position Po3 (refer to T7 and thereafter in FIG. 16). Consequently, the above-described pushing out of the protruding plates 76 and ejection of the molded product by the protruding pins 78 are carried out.

The predetermined removal start time Tc is information which is appropriately determined in a manner so that movement of the ejector plate 46 toward the ejected position Po3 is started after the mold 12 has been opened to a certain degree. The predetermined removal start time Tc is stored in the storage unit 54 in advance. The predetermined removal start time Tc is appropriately referred to by the ejector control unit 66.

The removal control unit 84 serves to remove the support member 50 from between the mounting plate 38 and the ejector plate 46, after the start of advancement of the ejector plate 46 at the time when the mold 12 is opened (after T7 in FIG. 16).

The advancement of the ejector plate 46 at the time when the mold 12 is opened refers to the advancement thereof toward the aforementioned ejected position Po3. The determination as to whether or not the ejector plate 46 has started to advance at the time when the mold 12 is opened can be achieved by the removal control unit 84 referring to the elapsed time t3 and the predetermined removal start time Tc, in the same manner as that of the ejector control unit 66, for example. Alternatively, for example, when the ejector control unit 66 starts the advancement of the ejector plate 46, a notification may be issued to the removal control unit 84 from the ejector control unit 66.

When the ejector plate 46 starts to advance toward the ejected position Po3, the gap g′, which is filled by execution of the ejector support step S4, is created again between the ejector plate 46 and the support member 50 (refer to FIG. 14).

The removal control unit 84 prevents the support member 50 and the ejector plate 46 from rubbing against each other, by carrying out removal of the support member 50 after the gap g′ has been created. As a result, the support member 50 and the ejector plate 46 are prevented from rubbing against each other.

It should be noted that the movement of the ejector plate 46 to the ejected position Po3 and the removal of the support member 50 may be started after the movable platen 34 has arrived at the mold opening position (from T8 and thereafter in FIG. 16).

### Exemplary Modification 2

The insertion control step S3 may be initiated prior to the end of the ejector advancing step S2. In such a case, it is preferable for a start timing at which the insertion control step S3 is started to be set in a manner so that the support member 50 that is inserted does not collide with the lower end of the advancing ejector plate 46. The start timing can be appropriately determined, for example, based on the moving speed of the advancing ejector plate 46, and the moving distance and the moving speed of the support member 50 that is inserted.

### Exemplary Modification 3

In the embodiment and the respective exemplary modifications thereof described above, a description has been given of a case in which the control device 24 performs various controls based on the time measured by the time keeping unit 62. However, the configuration of the control device 24 is not necessarily limited to this feature.

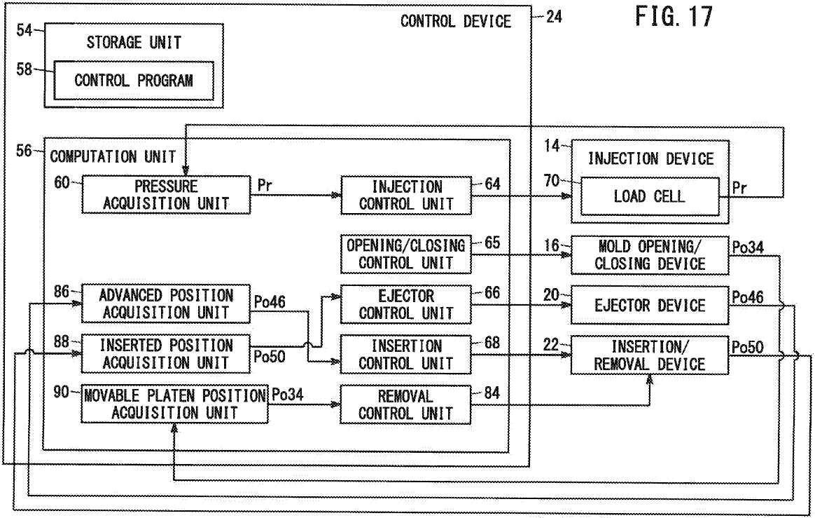

FIG. 17 is a configuration diagram of the control device 24 according to a third exemplary modification.

As shown in FIG. 17, the control device 24 of the present exemplary modification includes an advanced position acquisition unit 86, an inserted position acquisition unit 88, and a movable platen position acquisition unit 90. As shown in FIG. 17, according to the present exemplary modification, the time keeping unit 62 (the forward movement time keeping unit 72, the insertion time keeping unit 74, and the mold opening time keeping unit 82) described in the embodiment and the other exemplary modifications may be omitted from the configuration of the control device 24. Moreover, similarly to the first exemplary modification, the content of the control program 58 is appropriately changed in accordance with the configuration of the computation unit 56 of the present exemplary modification.

The advanced position acquisition unit 86 serves to acquire a position Po46 of the ejector plate 46 in the moving direction. Further, the inserted position acquisition unit 88 serves to acquire a position Po50 of the support member 50 in the insertion direction. In addition, the movable platen position acquisition unit 90 serves to acquire a position Po34 of the movable platen 34 in the opening direction of the mold 12. These respective acquired positions Po46, Po50, and Po34 can be acquired from the detection results of position sensors that are appropriately provided in the injection molding machine 10 and that detect the positions of the detection targets.

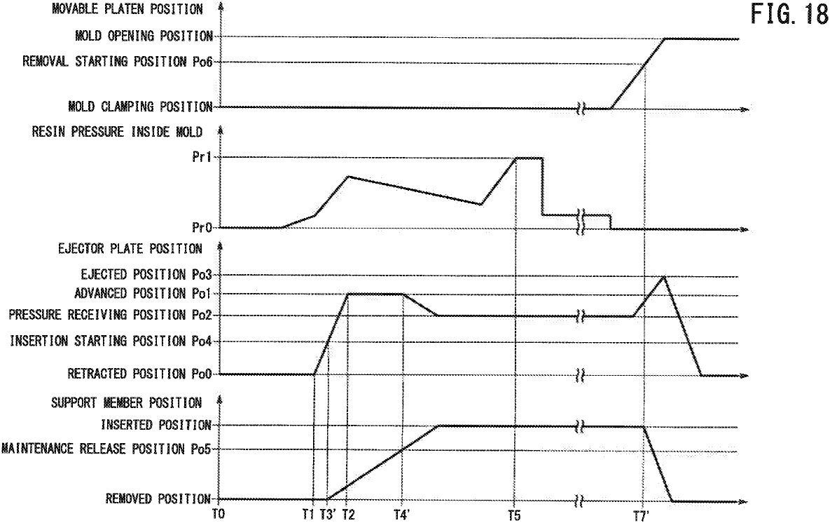

FIG. 18 is a time chart illustrating respective transitions of the position Po34 of the movable platen 34 in the opening/closing direction, the position Po46 of the ejector plate 46 in the opening/closing direction, the position Po50 of the support member 50 in the insertion/removal direction, and the resin pressure Pr inside the mold 12, according to the third exemplary modification.

Hereinafter, while referring to FIG. 18, the control performed by each of the insertion control unit 68, the ejector control unit 66, and the removal control unit 84 will be sequentially described.

First, a description will be given concerning the insertion control unit 68 according to the present exemplary modification. In the present exemplary modification, in the case that the advancing ejector plate 46 has reached a predetermined insertion starting position Po4, the insertion control unit 68 initiates the insertion control step S3 that has been described in the embodiment. More specifically, as shown in FIG. 18, in the present modification, in the case that the advancing ejector plate 46 has arrived at the predetermined insertion starting position Po4, the insertion control unit 68 inserts the support member 50 into the gap g formed between the mounting plate 38 and the ejector plate 46.

The predetermined insertion starting position Po4 is determined in advance and is a position between the retracted position Po0 and the advanced position Po1. T3′ in FIG. 18 illustrates a point in time at which the ejector plate 46 has reached the predetermined insertion starting position Po4. As shown in FIG. 18, the ejector plate 46 passes through the predetermined insertion starting position Po4 between T1 and T2 (in the ejector advancing step S2) during which the ejector plate 46 moves from the retracted position Po0 to the advanced position Pol.

The predetermined insertion starting position Po4 can be stored in the storage unit 54 in advance. Whether or not the ejector plate 46 has arrived at the predetermined insertion starting position Po4 may be determined by the insertion control unit 68, based on the position Po46 acquired by the advanced position acquisition unit 86. Moreover, the predetermined insertion starting position Po4 may be the same position as the advanced position Po1 and the pressure receiving position Po2.

Next, a description will be given concerning the ejector control unit 66 according to the present exemplary modification. The ejector control unit 66 maintains the position of the ejector plate 46 in the advanced position Po1 during a period until the support member 50 reaches a predetermined maintenance release position Po5 in the insertion direction. The positional relationship between the ejector plate 46 and the support member 50 during this period is the same as that shown in FIG. 7, for example.

The predetermined maintenance release position Po5 can be stored in the storage unit 54 in advance. Whether or not the support member 50 has arrived at the predetermined maintenance release position Po5 in the insertion direction may be determined by the ejector control unit 66, based on the position Po50 acquired by the inserted position acquisition unit 88. T4′ in FIG. 18 illustrates a point in time at which the support member 50 has reached the predetermined maintenance release position Po5 in the insertion direction.

In the case that the support member 50 has reached the predetermined maintenance release position Po5, the ejector control unit 66 initiates the ejector support step S4 described in the embodiment. More specifically, in the case that the support member 50 has reached the predetermined maintenance release position Po5, the ejector control unit 66 retracts the ejector plate 46 to the pressure receiving position Po2,

Consequently, in the same manner as shown in FIG. 8, the ejector plate 46 can be supported by the support member 50. Thereafter, the injection control unit 64 may cause the resin pressure Pr to reach the target pressure Pr1 in the same manner as in the embodiment to achieve the gate sealing (the pressure maintaining control step S5).

Moreover, after T4′, the timing at which the support member 50 reaches the insertion position, and the timing at which the ejector plate 46 is retracted to the pressure receiving position Po2 are preferably the same. Alternatively, the timing at which the support member 50 reaches the insertion position may take place prior to the timing at which the ejector plate 46 is retracted to the pressure receiving position Po2. As a result, the support member 50 and the ejector plate 46 are prevented from rubbing against each other.

Finally, a description will be given concerning the removal control unit 84 according to the present exemplary modification. In the case that the movable platen 34 has reached a predetermined removal starting position Po6 in the opening direction, the removal control unit 84 removes the support member 50 from between the mounting plate 38 and the ejector plate 46.

The predetermined removal starting position Po6 is information that can be stored in the storage unit 54 in advance. Whether or not the movable platen 34 has reached the predetermined removal starting position Po6 in the opening direction may be determined by the removal control unit 84 based on the position Po34 acquired by the movable platen position acquisition unit 90. T7′ in FIG. 18 illustrates a point in time at which the movable platen 34 has reached the predetermined removal starting position Po6 in the opening direction.

In the same manner as in the embodiment, the control device 24 of the present exemplary modification is also capable of forming a molded product having a concave portion (hole portion) with good reliability.

It should be noted that the time keeping unit 62, the advanced position acquisition unit 86, the inserted position acquisition unit 88, and the movable platen position acquisition unit 90 may be combined together as appropriate. For example, the insertion control unit 68 may perform control based on the elapsed time t1, whereas the ejector control unit 66 may perform control based on the position Po50 of the support member 50.

### Exemplary Modification 4

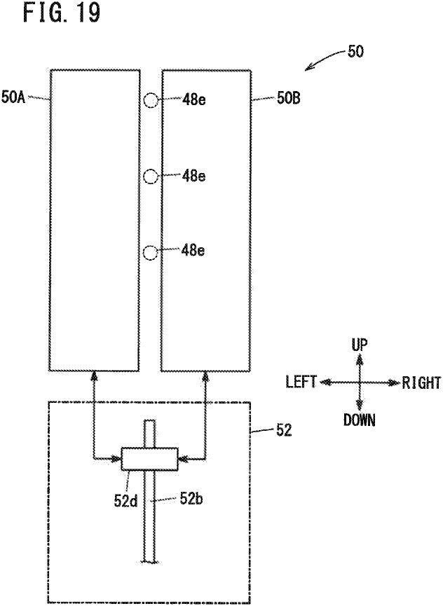

FIG. 19 is a configuration diagram of the support member 50 according to a fourth exemplary modification when viewed from the opening/closing direction.

The configuration of the support member 50, which is capable of avoiding a collision with the ejector rods 48e, is not limited to that shown in the embodiment (see FIG. 6). The support member 50 may be a combination of a plurality of plate members. For example, as shown in FIG. 19, such a support member 50 is configured as a set of a pair of plate members 50A and 50B, which are spaced apart from each other in the left/right direction.

When inserted into the gap g along the vertical direction, the support member 50 shown in FIG. 19 can avoid the ejector rods 48e, in the same manner as with the support member 50 shown in FIG. 6.

Moreover, in addition to what is shown in FIG. 19, the support member 50 is not limited to being plate-shaped, and may, for example, be a block-shaped member.

### Exemplary Modification 5

The direction in which the support member 50 is inserted is not limited to an upward direction as described in the embodiment. For example, the support member 50 may be inserted into the gap g by being moved in a downward direction from above the gap g. In this case, the support member 50 (the insertion/removal device 22) may be disposed above the mold 12. Alternatively, the support member 50 may be inserted from the left side or the right side of the gap g. In this case, the support member 50 (the insertion/removal device 22) may be disposed to the left or the right of the mold 12. Further, similarly to the insertion direction, the removal direction of the support member 50 is not limited to being a downward direction as described in the embodiment.

### Exemplary Modification 6

The unit for detecting the resin pressure Pr is not limited to being the load cell 70 that is attached to the screw 28. For example, a cavity pressure sensor (pressure sensor) may be provided in the mold 12, and the resin pressure Pr may be acquired from the cavity pressure sensor.

### Exemplary Modification 7

Although the injection molding machine 10 of the embodiment is equipped with the injection device 14, which is a so-called in-line injection device, the injection device 14 is not limited to being an in-line type.

Similarly, although the injection molding machine 10 of the embodiment realizes the opening and closing of the mold 12 (the movement of the movable platen 34) by means of the so-called toggle type toggle link mechanism 36, the mechanism that realizes the opening and closing of the mold 12 is not limited to being a toggle type.

### Exemplary Modification 8

The control device 24 may be applied to the injection molding machine 10 of vertical type. In the case that the injection molding machine 10 is a vertical injection molding machine, the direction of gravity is the opening/closing direction of the mold 12. In this case, the ejector plate 46 advances and retracts (moves forward and backward) along the direction of gravity. Further, the gap g expands along the direction of gravity accompanying the advancement of the ejector plate 46.

The insertion/removal direction of the support member 50 in the present exemplary modification can be appropriately determined so that the support member 50 can be inserted and removed into and from the gap g that expands along the direction of gravity. For example, although not limited to this feature, the direction of insertion can be a leftward direction and the direction of removal can be a rightward direction. The opening/closing direction shown in FIG. 1 may be the insertion/removal direction in the present exemplary modification.

### Exemplary Modification 9

The above-described respective modifications may be appropriately combined within a range in which no technical inconsistencies occur.

### Inventions That Can Be Obtained From the Embodiment

The inventions that can be grasped from the above-described embodiment and the modifications thereof will be described below.

### First Invention

Provided is the control device (24) for the injection molding machine (10), the injection molding machine (10) including the movable platen (34) that moves in the opening/closing direction of the mold (12), the mounting plate (38) provided on the mold (12) side of the movable platen (34), the spacer (40) that connects the mold (12) and the mounting plate (38) in a manner so that the mold (12) is opened and closed accompanying movement of the movable platen (34) in the opening/closing direction, the spacer (40) forming the ejector movable space (42) between the mold (12) and the mounting plate (38), the ejector plate (46) which is provided in the ejector movable space (42) and advances and retracts toward and from the mold (12), the ejector pins (44) which are provided on the ejector plate (46) and project out toward the mold (12), the support member (50) that is inserted into and removed from the gap (g) formed between the mounting plate (38) and the ejector plate (46) that has advanced, and the injection unit (14) that injects the plasticized resin (R), the control device (24) for the injection molding machine (10) comprising the pressure acquisition unit (60) that acquires the resin pressure (Pr) inside the mold (12), the injection control unit (64) that controls the injection unit (14) to thereby inject the resin (R) into the interior of the mold (12) that has been closed, and cause the resin pressure (Pr) to reach the predetermined target pressure (Pr1), the ejector control unit (66) which causes the ejector plate (46) to advance prior to the resin pressure (Pr) reaching the predetermined target pressure (Pr1), to thereby project the ejector pins (44) into the interior of the mold (12) and impart at least one of the concave portion or the hole portion to the shape of the resin (R) inside the mold (12), and the insertion control unit (68) which inserts the support member (50) into the gap (g) prior to the resin pressure (Pr) reaching the predetermined target pressure (Pr1), to thereby cause the ejector plate (46) that receives the resin pressure (Pr) to be supported by the support member (50) and the mounting plate (38).

In accordance with such features, the control device (24) for the injection molding machine (10) is provided, which is capable of forming the molded product having a concave shape and a hole portion with good reliability.

There may further be provided the forward movement time keeping unit (72) that measures the forward movement time (t1) which is an elapsed time from when the ejector plate (46) has started to advance prior to the resin pressure (Pr) reaching the predetermined target pressure (Pr1), wherein, in the case that the forward movement time (t1) has reached the predetermined insertion start time (Ta), the insertion control unit (68) may insert the support member (50) into the gap (g). In accordance with such features, it is easy to adjust the insertion timing of the support member (50) to the timing after the gap (g) has sufficiently expanded. As a result, a collision between the inserted support member (50) and the advancing ejector plate (46) can be prevented.

There may further be provided the advanced position acquisition unit (86) that acquires the position of the ejector plate (46) in the opening/closing direction, wherein, in the case that the advancing ejector plate (46) has reached the predetermined insertion starting position (Po4) prior to the resin pressure (Pr) reaching the predetermined target pressure (Pr1), the insertion control unit (68) may insert the support member (50) into the gap (g). In accordance with such features, it is easy to adjust the insertion timing of the support member (50) to the timing after the gap (g) has sufficiently expanded. As a result, a collision between the inserted support member (50) and the advancing ejector plate (46) can be prevented.

There may further be provided the insertion time keeping unit (74) that measures the insertion time (t2), which is an elapsed time from when the support member (50) has started to move toward the gap (g), wherein the ejector control unit (66) may maintain the position of the ejector plate (46) in the opening/closing direction at the predetermined advanced position (Po1) closer to the mold (12) side than the support member (50) until the insertion time (t2) reaches the predetermined maintenance release time (Tb), and may release the maintenance thereof after the insertion time (t2) has reached the predetermined maintenance release time (Tb). In accordance with such features, the ejector plate (46) is not retracted when the support member (50) is inserted into the gap (g), and therefore, the insertion of the support member (50) into the gap (g) is satisfactorily achieved. Further, it is possible to reduce the load on the drive device (the first linear motion mechanism 48) for the ejector plate (46) after the support member (50) has been inserted into the gap (g).

There may further be provided the inserted position acquisition unit (88) that acquires the position of the support member (50) in the insertion direction, wherein the ejector control unit (66) may maintain the position of the ejector plate (46) in the opening/closing direction at the predetermined advanced position (Po1) closer to the mold (12) side than the support member (50) until the support member (50), which is moving toward the gap (g), reaches the predetermined maintenance release position (Po5), and may release the maintenance thereof after the support member (50) has reached the predetermined maintenance release position (Po5). In accordance with such features, the ejector plate (46) is not retracted when the support member (50) is inserted into the gap (g), and therefore, the insertion of the support member (50) into the gap (g) is satisfactorily achieved. Further, it is possible to reduce the load on the drive device (the first linear motion mechanism 48) for the ejector plate (46) after the support member (50) has been inserted into the gap (g).

The injection control unit (64) may maintain the resin pressure (Pr) below the predetermined target pressure (Pr1) until the ejector plate (46) is released from being maintained at the predetermined advanced position (Po1). In accordance with this feature, the timing at which the resin pressure (Pr) reaches the predetermined target pressure (Pr1) can be easily adjusted to the timing after the ejector plate (46) has been placed in a state of being supported by the support member (50).

The injection molding machine (10) may further include the protruding plates (76) provided in the ejector movable space (42) on the side closer to the mold (12) side than the ejector plate (46), so as to avoid the ejector pins (44), and the protruding pins (78) provided on the protruding plates (76) and projecting out toward the mold (12), wherein, at a time when the mold (12) is opened, the ejector control unit (66) may cause the ejector plate (46) to advance to thereby push in the protruding plates (76) toward the mold (12) in order to eject the molded product, which is made from the solidified resin (R), from the mold (12) with the protruding pins (78), and the control device (24) may further comprise the removal control unit (84) that removes the support member (50) from between the mounting plate (38) and the ejector plate (46) after the ejector plate (46) starts to advance at the time when the mold (12) is opened. In accordance with such features, the control to remove the support member (50) is performed after the support member (50) and the ejector plate (46) have been separated from each other. As a result, the support member (50) and the ejector plate (46) are prevented from rubbing against each other at the time when the support member (50) is removed.

There may further be provided the mold opening time keeping unit (82) that measures the mold opening time (t3) which is an elapsed time from when opening of the mold has started, wherein, in the case that the mold opening time (t3) has reached the predetermined removal start time (Tc), the ejector control unit (66) may advance the ejector plate (46) to push in the protruding plates (76) toward the mold (12). In accordance with such features, it is possible to prevent the ejection of the molded product from being performed by the protruding pins (78) prior to the mold (12) being fully opened.

In the case that the mold opening time (t3) has reached the predetermined removal start time (Tc), the removal control unit (84) may remove the support member (50) from between the mounting plate (38) and the ejector plate (46). In accordance with this feature, the support member (50) and the ejector plate (46) are prevented from rubbing against each other at the time when the support member (50) is removed.

There may further be provided the movable platen position acquisition unit (90) that acquires the position of the movable platen (34) in the opening/closing direction at the time when the mold is opened, wherein, in the case that the movable platen (34) has reached the predetermined removal starting position (Po6) at the time when the mold is opened, the ejector control unit (66) may advance the ejector plate (46) to push in the protruding plates (76) toward the mold (12). In accordance with such features, it is possible to prevent the ejection of the molded product from being performed by the protruding pins (78) prior to the mold (12) being fully opened.

In the case that the movable platen (34) has reached the predetermined removal starting position (Po6) at the time when the mold is opened, the removal control unit (84) may remove the support member (50) from between the mounting plate (38) and the ejector plate (46). In accordance with this feature, the support member (50) and the ejector plate (46) are prevented from rubbing against each other at the time when the support member (50) is removed.

### Second Invention

Provided is the control method for the injection molding machine (10), the injection molding machine (10) including the movable platen (34) that moves in the opening/closing direction of the mold (12), the mounting plate (38) provided on the mold (12) side of the movable platen (34), the spacer (40) that connects the mold (12) and the mounting plate (38) in a manner so that the mold (12) is opened and closed accompanying movement of the movable platen (34) in the opening/closing direction, the spacer (40) forming the ejector movable space (42) between the mold (12) and the mounting plate (38), the ejector plate (46) which is provided in the ejector movable space (42) and advances and retracts toward and from the mold (12), the ejector pins (44) which are provided on the ejector plate (46) and project out toward the mold (12), the support member (50) that is inserted into and removed from the gap (g) formed between the mounting plate (38) and the ejector plate (46) that has advanced, and the injection unit (14) that injects the plasticized resin (R), the control method for the injection molding machine (10) comprising the injection control step of controlling the injection unit (14) to thereby inject the resin (R) into the interior of the mold (12) that has been closed, the ejector advancing step of, after the injection control step is started, causing the ejector plate (46) to advance to thereby project the ejector pins (44) into the interior of the mold (12) and impart at least one of the concave portion or the hole portion to the shape of the resin (R) inside the mold (12), the insertion control step of inserting the support member (50) into the gap (g) after the ejector advancing step is started, and the pressure maintaining control step of, after the insertion control step is started, causing the resin pressure (Pr) inside the mold (12) to reach the predetermined target pressure (Pr1) while the ejector plate (46) is supported by the support member (50) and the mounting plate (38).

In accordance with such features, the control method for the injection molding machine (10) is provided, which is capable of forming the molded product having a concave shape and a hole portion with good reliability.

1. A control device for an injection molding machine,
wherein the injection molding machine includes:
a movable platen configured to move in an opening/closing direction of a mold;
a mounting plate provided on a side of the mold of the movable platen;
a spacer configured to connect the mold and the mounting plate in a manner so that the mold is opened and closed accompanying movement of the movable platen in the opening/closing direction, the spacer forming an ejector movable space between the mold and the mounting plate;
an ejector plate provided in the ejector movable space, and configured to advance and retract toward and from the mold;
an ejector pin (44) provided on the ejector plate, and configured to project out toward the mold;
a support member configured to be inserted into and removed from a gap formed between the mounting plate and the ejector plate that has advanced; and
an injection unit configured to inject a resin that has been plasticized,
the control device for the injection molding machine comprising:
a pressure acquisition unit configured to acquire a resin pressure inside the mold;
an injection control unit configured to control the injection unit to thereby inject the resin into an interior of the mold that has been closed, and cause the resin pressure to reach a predetermined target pressure;
an ejector control unit configured to cause the ejector plate to advance prior to the resin pressure reaching the predetermined target pressure, to thereby project the ejector pin into the interior of the mold and impart at least one of a concave portion or a hole portion to a shape of the resin inside the mold; and
an insertion control unit (68)-configured to insert the support member into the gap prior to the resin pressure reaching the predetermined target pressure, to thereby cause the ejector plate that receives the resin pressure to be supported by the support member and the mounting plate.

2. The control device for the injection molding machine according to claim 1, further comprising a forward movement time keeping unit configured to measure a forward movement time, which is an elapsed time from when the ejector plate has started to advance prior to the resin pressure reaching the predetermined target pressure,
wherein, in a case that the forward movement time has reached a predetermined insertion start time, the insertion control unit inserts the support member into the gap.

3. The control device for the injection molding machine according to claim 1, further comprising an advanced position acquisition unit configured to acquire a position of the ejector plate in the opening/closing direction,
wherein, in a case that the ejector plate that is advancing has reached a predetermined insertion starting position prior to the resin pressure reaching the predetermined target pressure, the insertion control unit inserts the support member into the gap.

4. The control device for the injection molding machine according to claim 1, further comprising an insertion time keeping unit configured to measure an insertion time, which is an elapsed time from when the support member has started to move toward the gap,
wherein the ejector control unit maintains a position of the ejector plate in the opening/closing direction at a predetermined advanced position closer to the side of the mold than the support member until the insertion time reaches a predetermined maintenance release time, and releases maintenance thereof after the insertion time has reached the predetermined maintenance release time.

5. The control device for the injection molding machine according to claim 1, further comprising an inserted position acquisition unit configured to acquire a position of the support member in an insertion direction,
wherein the ejector control unit maintains a position of the ejector plate in the opening/closing direction at the predetermined advanced position closer to the side of the mold than the support member until the support member, which is moving toward the gap, reaches a predetermined maintenance release position, and releases maintenance thereof after the support member has reached the predetermined maintenance release position.

6. The control device for the injection molding machine according to claim 4, wherein
the injection control unit maintains the resin pressure below the predetermined target pressure until the ejector plate is released from being maintained at the predetermined advanced position.

7. The control device for the injection molding machine according to claim 1, wherein
the injection molding machine further includes: a protruding plate provided in the ejector movable space on a side closer to the side of the mold than the ejector plate, so as to avoid the ejector pin; and a protruding pin provided on the protruding plate and configured to project out toward the mold,
wherein, at a time when the mold is opened, the ejector control unit causes the ejector plate to advance to thereby push in the protruding plate toward the mold in order to eject a molded product, which is made from the resin that has been solidified, from the mold with the protruding pin, and
the control device further comprises a removal control unit configured to remove the support member from between the mounting plate and the ejector plate after the ejector plate starts to advance at the time when the mold is opened.

8. The control device for the injection molding machine according to claim 7, further comprising a mold opening time keeping unit configured to measure a mold opening time, which is an elapsed time from when opening of the mold has started,
wherein, in a case that the mold opening time has reached a predetermined removal start time, the ejector control unit causes the ejector plate to advance to push in the ejector plate toward the mold.

9. The control device for the injection molding machine according to claim 8, wherein
in the case that the mold opening time has reached the predetermined removal start time, the removal control unit removes the support member from between the mounting plate and the ejector plate.

10. The control device for the injection molding machine according to claim 7, further comprising a movable platen position acquisition unit configured to acquire a position of the movable platen in the opening/closing direction at the time when the mold is opened,
wherein, in a case that the movable platen has reached a predetermined removal starting position at the time when the mold is opened, the ejector control unit causes the ejector plate to advance to push in the protruding plate toward the mold.

11. The control device for the injection molding machine according to claim 10, wherein
in the case that the movable platen has reached the predetermined removal starting position at the time when the mold is opened, the removal control unit removes the support member from between the mounting plate and the ejector plate.

12. A control method for an injection molding machine,
wherein the injection molding machine includes:
a movable platen configured to move in an opening/closing direction of a mold;
a mounting plate provided on a side of the mold of the movable platen;
a spacer configured to connect the mold and the mounting plate in a manner so that the mold is opened and closed accompanying movement of the movable platen in the opening/closing direction, the spacer forming an ejector movable space between the mold and the mounting plate;
an ejector plate provided in the ejector movable space, and configured to advance and retract toward and from the mold;
an ejector pin provided on the ejector plate, and configured to project out toward the mold;
a support member configured to be inserted into and removed from a gap formed between the mounting plate and the ejector plate that has advanced; and
an injection unit configured to inject a resin that has been plasticized,
the control method for the injection molding machine comprising:
an injection control step of controlling the injection unit to thereby inject the resin into an interior of the mold that has been closed;
an ejector advancing step of, after the injection control step is started, causing the ejector plate to advance to thereby project the ejector pin into the interior of the mold and impart at least one of a concave portion or a hole portion to a shape of the resin inside the mold;
an insertion control step of inserting the support member into the gap after the ejector advancing step is started; and
a pressure maintaining control step of, after the insertion control step is started, causing a resin pressure inside the mold to reach a predetermined target pressure while the ejector plate is supported by the support member and the mounting plate.
